(19) United States
(12) Patent Application Publication
(10) Pub. No.: US 2024/0222992 A1
(43) Pub. Date: Jul. 4, 2024

(54) METHOD AND DEVICE FOR CONTROLLING THE LEVEL OF CHARGE OF A TRACTION BATTERY OF AN ELECTRIC VEHICLE

(71) Applicant: RENAULT s.a.s., Boulogne-Billancourt (FR)

(72) Inventor: Aurelien GOHIER, Massy (FR)

(73) Assignee: RENAULT s.a.s., Boulogne-Billancourt (FR)

(21) Appl. No.: 18/605,421

(22) Filed: Mar. 14, 2024

Related U.S. Application Data
(63) Continuation of application No. 17/283,741, filed on Apr. 8, 2021, now abandoned.

(30) Foreign Application Priority Data
Oct. 9, 2018 (FR) 18 59336

(51) Int. Cl. H02J 7/00; B60L 53/14; B60L 53/31; B60L 58/13; H02J 7/04

(52) U.S. Cl. CPC H02J 7/0069; B60L 53/14; B60L 53/31; B60L 58/13; H02J 7/007; H02J 7/04; B60L 2240/547; B60L 2240/549

(57) ABSTRACT

A method for controlling a level of charge of a traction battery of an electric vehicle connected to an electricity distribution grid by way of a charger during a downtime phase of the vehicle. The method includes a first step of forcibly discharging the battery, performed in a discharging circuit associated with the battery, with a discharge current that is calibrated in terms of strength with respect to the nominal capacity of the battery, so as to slowly and completely discharge the battery to its minimum voltage, and a step of normally charging the battery with a setpoint charging current prescribed by the charger or the battery, so as to charge the battery to a useful level of charge of the battery.

### CROSS-REFERENCE TO RELATED APPLICATIONS

This application is a continuation of and claims benefit of priority under 35 U.S.C. § 120 from U.S. Ser. No. 17/283,741, filed Apr. 8, 2021, which is a National Stage Application of PCT/EP2019/076957, filed Oct. 4, 2019, which designated the U.S. and claims priority to French Patent Application No. 18 59336, filed Oct. 9, 2018; the entire contents of each of which are hereby incorporated by reference.

The present invention relates to a method and a device for regulating the level of charge of a traction battery of an electric vehicle. It applies in particular, but not exclusively, to the field of managing the level of charge of lithium-ion (Li-ion) batteries for rechargeable hybrid and electric vehicles.

To date, one of the main limiters on the growth of the use of electric vehicles has been the battery charging time, in particular compared with the time required to fill a combustion vehicle with fuel. Thus, new “fast” or “ultra-fast” charging Li-ion battery technologies, suitable for the automotive sector, have been developed, allowing the charging time to be decreased significantly. However, it has been observed that batteries allowing such fast or ultra-fast charging, i.e. capable of accepting large charging currents, are more vulnerable to experiencing a deterioration in their characteristics over time. In other words, the capability of the battery to accept fast or ultra-fast charging results in an increase in the probability of occurrence of battery aging mechanisms, of physicochemical origin. These mechanisms are promoted with a large current, below a certain charging time threshold, causing a decrease in battery capacity, such that the range of the vehicle may be severely affected. Fast or ultra-fast charging therefore has a negative effect on the aging of Li-ion batteries, and therefore on vehicle performance.

In order nevertheless to address the challenge of battery fast charging while limiting their propensity to age more quickly, one known solution consists in adjusting the level of the charging currents according to the state of charge of the battery and the temperature. However, beyond a certain demand for a decrease in charging time, it has been observed that this strategy does not prevent increased deterioration of the capacity of the battery in comparison with slow charging.

Additionally, it has been demonstrated that certain intermediate levels of charge or excessively high temperatures might be conditions that negatively affect the service life of the battery. Patent document FR2992779, filed by the applicant, discloses a method for regulating the level of charge of a traction battery of an electric vehicle connected to an electricity distribution network via a bidirectional charger, allowing battery service life to be maximized. The method described in this document is based on the principle of limiting the time spent by a battery at excessively high levels of charge when it is not in use. Thus, in phases when the vehicle is not in use, when the battery of the vehicle is charging, as much energy as possible is put back into the electricity distribution network, which maximizes the service life of the battery, and then this energy is taken back later shortly before the vehicle is actually used again. This method thus first comprises a step of discharging the battery into the network through the bidirectional charger, to an optimum level of charge allowing minimization of loss of capacity of the battery as a function of an estimated time for which the battery will not be used, and then a step of charging the battery to a level of charge required for a journey known in advance.

However, while this method provides increased resistance to calendar aging of the battery (i.e. limits loss of capacity when the battery is at rest), it in no way addresses the problem of loss of range of the vehicle as mentioned above, which is due to the deterioration in battery capacity resulting from successive fast charging operations, in particular charging operations of which the duration is below a critical threshold for the chemistry of the battery.

In addition, in the aforementioned document, the implementation of the steps for modifying the level of state of charge of the battery in phases when not in use with a view to maximizing its service life requires the use of a bidirectional charger to be able to send energy back into the electricity distribution network. This is a relatively complex and expensive device, which constitutes a limitation on the deployment of this solution.

Thus, an aim of the present invention is to provide a method and a device, which are simple to implement, that make it possible to overcome, at least in part, the problem of loss of capacity caused by the implementation of cycles of fast-charging Li-ion batteries, in particular those used as traction batteries for electric vehicles.

To that end, the invention relates to a method for regulating the level of charge of a traction battery of an electric vehicle connected to an electricity distribution network via a charger during a downtime phase of the vehicle, characterized in that it comprises:
a first step of forcibly discharging the battery, performed into a discharge circuit associated with the battery, with a discharge current that is calibrated in terms of intensity with respect to the nominal capacity of the battery, so as to slowly and completely discharge the battery to its minimum voltage, a step of normally charging the battery with a setpoint charging current prescribed by the charger or the battery, so as to charge the battery to a useful level of charge of the battery.

According to one embodiment, said step of normally charging the battery is preceded by at least one intermediate sequence of charging and discharging the battery, successively comprising:
a step of restrained charging of the battery, with a restrained charging current, smaller than the setpoint charging current, so as to slowly charge the battery to its maximum voltage, and
a second step of forcibly discharging the battery, performed into the discharge circuit associated with the battery, with said calibrated discharge current, so as to slowly and completely discharge the battery to its minimum voltage again.

Advantageously, the first and second steps of forcibly discharging the battery are performed into a discharge resistor, said discharge resistor being connected to the terminals of the battery during said first and second steps of forced discharging and disconnected from the terminals of the battery during said steps of normal and restrained charging, said discharge resistor setting said calibrated discharge current.

Advantageously, said calibrated discharge current is at most equal to one tenth of the value of the nominal capacity of the battery.

Advantageously, said restrained charging current is at most equal to one tenth of the value of the nominal capacity of the battery.

Preferably, said setpoint charging current is suitable for fast-charging the battery.

The invention also relates to a device for regulating the level of charge of a traction battery of an electric vehicle connected to an electricity distribution network via a charger during a downtime phase of the vehicle, characterized in that it comprises a discharge circuit for discharging the battery able to be electrically connected to said battery and a control module designed to selectively connect said discharge circuit to said battery in order to discharge said battery and implement the method as described above.

Advantageously, the discharge circuit comprises a discharge resistor, each terminal of which is connected to the respective terminals of the battery via a switch comprising a movable contact driven by said control module between two positions, for connecting and disconnecting the terminals of the resistor to and from the terminals of the battery.

Advantageously, the discharge resistor is integrated into a housing of said battery.

The invention also relates to an electric vehicle comprising a device as described above.

Other features and advantages of the invention will become apparent from reading the description provided below of one particular embodiment of the invention, given by way of non-limiting indication, with reference to the appended drawings, in which:

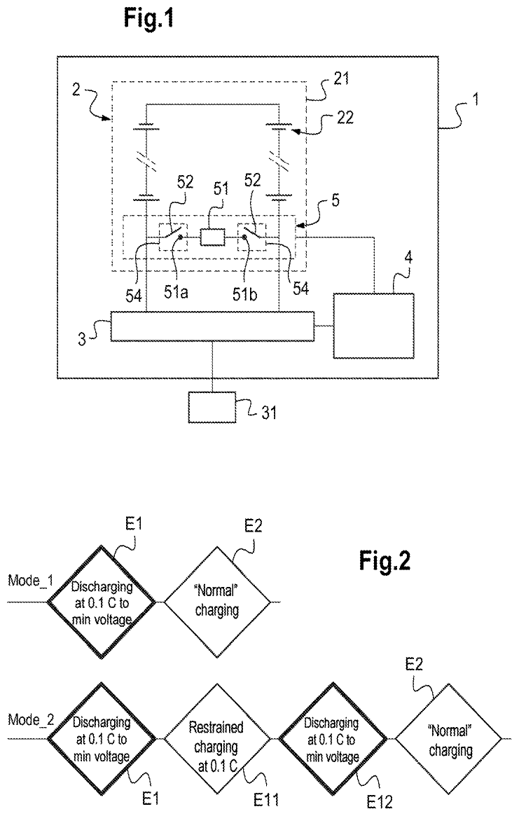

FIG. 1 illustrates a circuit diagram of an exemplary electric vehicle equipped with a device for regulating the level of charge of the battery according to the invention;

FIG. 2 is a block diagram illustrating two embodiments of the method of the invention.

FIG. 1 shows a circuit diagram of an exemplary implementation of the invention in an electric motor vehicle 1, provided with an electric motor (not shown). The electric motor of the vehicle according to this example is supplied with power by a traction battery 2, of lithium-ion type, comprising, in a manner known per se, a battery housing 21 in which a plurality of electrochemical accumulators 22, or cells, are arranged in series, including a rechargeable electrochemical system designed to supply a nominal voltage.

The vehicle of this example also comprises a battery charger 3. The battery charger 3 is designed to be connected to an electricity distribution network 31 in order to charge the vehicle battery. The battery charger 3 is driven by a control module 4, comprising a computer designed to control the charging of the battery 2 from the electrical network 31 via the charger 3, when the vehicle is at a standstill and connected to the network 31 for charging.

In this context, in which the vehicle is at a standstill and connected to the electricity distribution network 31 for charging, the invention proposes the implementation of a protocol that makes it possible to recover a portion of the lost battery capacity, in particular at the end of the phases of fast charging previously undergone by the battery.

Specifically, it has been observed that this loss of capacity of the Li-ion battery resulting from successive fast charging operations may be attributed to parasitic electrochemical reactions, exacerbated by the large charging currents, resulting in particular in deposition of lithium metal (“Li plating”) on the surface of the negative electrode reacting with the electrolyte in which it is immersed. A principle of the invention is to provide a simple device associated with a specific protocol in order to recover a temporarily lost reversible portion of the battery capacity associated with this phenomenon and thus increase the service life of the electric vehicle, despite the implementation of fast charging.

To that end, the device of the invention comprises a discharge circuit 5 associated with the battery 2. This discharge circuit comprises a single discharge resistor 51, which may therefore be easily integrated into the battery housing 21 in which the cells 22 are arranged. More precisely, one terminal 51a of the discharge resistor 51 is connected to the positive terminal of the battery 2 via a movable contact 52 of a first switch 54 such as a relay and the other terminal 51b of the discharge resistor 51 is connected to the negative terminal of the battery via a movable contact 52 of a second switch 54 such as a relay. The movable contact 52 of the first and second switches 54 may take two positions, respectively a first, “open” position, in which the terminals 51a and 51b of the discharge resistor 51 are not connected to the positive and negative terminals of the battery, as illustrated in FIG. 1, and a second, “closed” position, in which the terminals 51a and 51b of the discharge resistor 51 are connected to the positive and negative terminals of the battery.

The positions of the first and second switches 54 of the discharge system associated with the battery are controlled by the control module 4, which is designed to determine the position of their movable contact 52 from among the first and second positions according to different charging strategies that the present invention is able to offer the driver when the vehicle is at a standstill and connected to the network for charging, as will be described in more detail below.

The method of the invention makes it possible to provide at least two strategies, denoted by Mode_1 and Mode_2 in FIG. 2, allowing the recovery of the reversible portion of the battery capacity which was lost in particular at the end of phases of fast-charging the battery.

For both strategies, forced discharging of the battery is first controlled in a first step E1. Thus, in this first step, the discharge resistor 51 is connected between the terminals of the battery, by driving the two movable contacts 52 of the relays 54 so that they are in the closed position, via the control module 4. The discharge resistor 51 thus connected to the battery allows the effective discharge current in the discharging step E1 to be set. According to the invention, the discharge resistor is sized so as to allow only a very small discharge current to flow, capable of slowly discharging the battery to its minimum voltage. To give a preferred exemplary embodiment, the discharge resistor 51 is sized so as to adjust the intensity of the discharge current to at most one tenth of the nominal capacity of the battery. This is referred to as discharging at 0.1 C, where C is the nominal energy capacity of the battery, expressed in Ah, given for a total discharge over 10 hours. This means that the battery, in this discharging step E1, will deliver a current with an intensity ten times lower than the capacity of the battery over a period of time of 10 hours. In other words, according to this exemplary embodiment, the battery will discharge slowly to its minimum voltage over a period of time of 10 hours.

Thus, this first step E1 of slowly and completely discharging the battery makes it possible to restore a portion of the capacity of the battery, by making the “Li plating” phenomenon that occurs during charging partially reversible, which phenomenon is a significant source of battery deterioration, and is promoted with a large current during the use of fast charging.

The minimum voltage or stop voltage allows the total discharge threshold of the battery to be determined and allows the battery to be protected. Thus, as soon as the control module 4 detects the minimum voltage, by virtue of voltage sensors arranged at the terminals of the cells forming the battery, it disconnects the discharge resistor 51 from the battery by driving the two movable contacts 52 of the relays 54 so as to be in the open position, which allows overdischarging of the battery, and negative consequences on battery service life, to be avoided.

At the end of the first step E1 of slowly and completely discharging the battery, the method of the invention may continue according to two different sequences, corresponding to the two strategies denoted by Mode_1 and Mode_2 in FIG. 2, corresponding, respectively, to a first, “fast” mode and to a second, “slow” mode.

In the fast mode, following the first step E1, a step E2 of normally charging the battery via the charger 3 connected to the electricity distribution network is controlled. During this step, the discharge resistor 51 is therefore disconnected from the battery, as explained above. This normal charging step is performed with a setpoint charging current, which is that prescribed by the charger or the battery. In other words, normal charging is charging at a level of power limited by the capability of the charger or of the battery.

The normal charging step E2 may also be performed using a fast charging regime, if available, in other words if high charging power is available through the network and the charger. In this case, the setpoint charging current is set at a value such that it allows fast charging of the battery, capable of charging the battery so as to obtain an acceptable level of charge as quickly as possible. For example, this charging current could be set at at least 40% of the battery capacity.

The battery is charged to a required level of charge, corresponding for example to a minimum level of charge needed to make a known journey.

By applying the strategy according to the fast mode, the battery may be charged immediately after the first, slow discharging step E1 to the required level of charge, including using a fast charging regime, without this being to the detriment of battery service life. Specifically, in a next phase of charging the vehicle, the application according to the invention of the preliminary step E1 of slowly discharging the battery will make it possible to restore a portion of the lost capacity of the battery, as explained above.

As a variant, at the end of the first step E1 of slowly and completely discharging the battery, the method of the invention may continue according to a second mode, called slow mode.

In this slow mode, step E2 of normally charging the battery, as explained above, is preceded by an intermediate sequence of charging and discharging the battery.

Thus, during this intermediate sequence, a step E12 of restrained charging of the battery via the charger 3 connected to the electricity distribution network is first controlled. During this step E12, the discharge resistor 51 is therefore also disconnected from the battery, according to the principles set out above, like for the normal charging step E2. However, this restrained charging step E12 is performed with a restrained charging current, lower than the setpoint charging current corresponding to the maximum charging current prescribed by the charger or the battery, so as to slowly charge the battery to its maximum voltage. According to one preferred exemplary embodiment, the control module 4 adjusts the intensity of the charging current to a level at most equal to one tenth of the nominal capacity of the battery. This means charging restrained at 0.1 C. This means that the battery, in this restrained charging step E12, will receive a current with an intensity ten times lower than the capacity of the battery over a period of time of 10 hours. In other words, according to this exemplary embodiment, the battery will charge slowly and completely to its maximum voltage over a period of time of 10 hours. When the control module 4 detects the maximum voltage, the slow charging is stopped.

Next, still in this intermediate sequence, once the battery is fully charged, a second step E12 of forcibly discharging the battery is then controlled, under conditions of implementation identical to those of the first discharging step E1. Thus, the discharge resistor 51 is connected to the battery again, so as to cause slow and complete discharging of the battery at 0.1 C, until the minimum voltage of the battery is reached.

At the end of this second slow and complete discharging of the battery implemented in step E12, the discharge resistor 51 is disconnected from the battery and step E2 of normally charging the battery is implemented as explained above with reference to the fast mode Mode_1. Thus, during this step E2, charging is provided to the required level of charge at a level of power limited by the capabilities of the charger or of the battery, potentially using a fast charging regime, if available.

The slow mode Mode_2 produces the same beneficial effects as the fast mode Mode_1 in terms of at least partially reversing the “Li plating” phenomenon, by virtue of the first step E1 of slowly and completely discharging the battery, which is implemented in both modes. In addition, the intermediate sequence that follows step E1, consisting of step E11 of slowly and completely charging the battery, followed by step E12 of slowly and completely discharging the battery, will allow the internal state of charge of the Li-ion cells of the battery to be re-homogenized, which avoids over-stressing some of their active regions and therefore prematurely degrading the cells of the battery, to the benefit of recovering a larger portion of the capacity of the battery that may be lost during phases of fast charging.

The slow mode Mode_2 is called slow with respect to the fast mode Mode_1 because it involves additional immobilization of the vehicle for 20 hours, according to the exemplary embodiment, due to the implementation of the intermediate sequence of steps E11 and E12 of slow charging and discharging at 0.1 C between steps E1 and E2. Thus, the fast mode may in particular be useful in the case of charging via charging points deployed in public spaces, where the charging and/or parking time may be limited.

Advantageously, before the start of charging, provision may be made to inform the driver of the time required before their vehicle is available again, once they have stopped and connected to the network for charging, if they select the option offered by the invention of recovering battery capacity according to one or the other of the two modes described above. This time required for the implementation of one or the other of the two modes will also depend on the state of charge of the vehicle.

The driver may also choose not to charge the battery according to one or the other of the two modes of the invention that allows battery capacity to be recovered, if the time required for the implementation of these two modes is not compatible with the driver's constraints. In that case, standard charging is implemented.

It should also be noted that slow and complete discharging of the battery as in steps E1 and E12 cannot be performed during normal use of the vehicle. In particular, when driving, phases of braking result in intermittent charging, which disrupts discharging and prevents the implementation of continuous slow and complete discharging. However, such discharging of the battery is required, at least prior to step E1, in order to allow the implementation of the different strategies for recovering battery capacity as explained above, during charging the vehicle battery. Thus, the association of the discharge circuit 5, controlled by the control module 4, with the battery makes these slow and complete discharges of the battery as required by the invention possible.

1. A method for regulating a level of charge of a traction battery of an electric vehicle connected to an electricity distribution network via a charger during a downtime phase of the vehicle, comprising:
forcibly discharging the battery a first time, performed into a discharge circuit associated with the battery, with a discharge current that is calibrated in terms of intensity with respect to the nominal capacity of the battery, so as to slowly and completely discharge the battery to a minimum voltage, and
normally charging the battery, with a setpoint charging current prescribed by the charger or the battery, so as to charge the battery to a useful level of charge of the battery.

2. The method as claimed in claim 1, wherein said normally charging the battery is preceded by at least one intermediate sequence of charging and discharging the battery, successively comprising:
restrained charging of the battery a second time, with a restrained charging current, smaller than the setpoint charging current, so as to slowly charge the battery to its maximum voltage, and
forcibly discharging the battery, performed into the discharge circuit associated with the battery, with said calibrated discharge current, so as to slowly and completely discharge the battery to its minimum voltage again.

3. The method as claimed in claim 2, wherein the forcibly discharging the battery the first and second times are performed into a discharge resistor, said discharge resistor being connected to the terminals of the battery during said forcibly discharging the battery the first and second times and disconnected from the terminals of the battery during said normal charging and said restrained charging, said discharge resistor setting said calibrated discharge current.

4. The method as claimed in claim 1, wherein said calibrated discharge current is at most equal to one tenth of the value of the nominal capacity of the battery.

5. The method as claimed in claim 2, wherein said restrained charging current is at most equal to one tenth of the value of the nominal capacity of the battery.

6. The method as claimed in claim 1, wherein said setpoint charging current is suitable for fast-charging the battery.

7. A device for regulating a level of charge of a traction battery of an electric vehicle connected to an electricity distribution network via a charger during a downtime phase of the vehicle, comprising:
a discharge circuit configured to discharge the battery and to be electrically connected to said battery; and
a control module configured to selectively connect said discharge circuit to said battery in order to discharge said battery and implement the method as claimed in claim 1.

8. The device as claimed in claim 7, wherein the discharge circuit comprises a discharge resistor, each terminal of which is connected to the respective terminals of the battery via a switch comprising a movable contact driven by said control module between two positions, to connect and disconnect the terminals of the resistor to and from the terminals of the battery.

9. The device as claimed in claim 8, wherein the discharge resistor is integrated into a housing of said battery.

10. An electric vehicle comprising the device as claimed in claim 7.
